(19) United States
(12) Patent Application Publication
(10) Pub. No.: US 2005/0221750 A1
(43) Pub. Date: Oct. 6, 2005

(54) Methods for automatically controlling functions at animal processing facilities and systems therefor

(76) Inventor: Stephen B. Austin, Raleigh, NC (US)

Correspondence Address: MACCORD MASON PLLC, 300 N. GREENE STREET, SUITE 1600, P. O. BOX 2974, GREENSBORO, NC, 27402, US

(21) Appl. No.: 10/804,876

(22) Filed: Mar. 20, 2004

(51) Int. Cl. A22C 21/00

(52) U.S. Cl. 452/177

(57) ABSTRACT

Automated systems and methods for controlling functions in an animal processing facility wherein at least one sensor is provided for sensing the presence of each animal unit at the input of a predetermined process or system and for counting and/or tracking each animal unit through the process or system using animal unit sensing outputs, while coordinating at least one function of the predetermined process or system in an automated, integrated manner based upon the animal unit sensing outputs.

### BACKGROUND OF THE INVENTION

(1) Field of the Invention

The present invention relates generally to animal processing methods and facilities and, more particularly, to methods for controlling functions such as water, power, gas, and equipment usage during processing at animal processing facilities, in particular at poultry processing facilities.

(2) Description of the Prior Art

Typically, animal or poultry processing systems and methods have become increasingly automated over time. By way of example, conveyor systems for use in poultry processing frequently require capabilities to sense whether or not a bird carried by the conveyor is passing a particular point, for example to count the number of birds being processed. However, considerable difficulties have been encountered in developing a sensing device which will operate satisfactorily and emit only one signal for each bird passing the sensing device.

Other prior art systems have generally relied on sensing the passage of part of the conveyor which carries the bird, usually sensing a carrier such as a trolley running on a continuous overhead conveyor. The only known sensors which remain largely unaffected by the difficult conditions in a poultry processing plant are sensors of the metal detection type which can still operate when coated with dirt, feathers and the like, but obviously such sensors cannot be used to detect the birds themselves. There are at least two reasons for not sensing the bird directly in many prior art applications, including erroneous extra signals or false positives and detector limitations.

Furthermore, using the information output for more than a basic counting function is not commonly found in the prior art, and, particularly, integration of automated counting outputs with other automated functions is not found. Thus, there exists a need to integrate automated counting outputs with other automated processes or systems within poultry processing applications.

Examples of prior art relevant to the present invention systems and methods include the following: U.S. Pat. No. 4,150,374 for Brook issued Apr. 17, 1979 for Sensing device for use in poultry processing, which teaches a sensing device for use with a poultry conveyor system to detect the passage of a poultry carcass supported on a carrier device arranged to move along a predetermined path includes two sensors, a first sensor which is actuated by passage of the carrier device and a second sensor which is actuated by the passage of the poultry carcass itself. The first and second sensing devices are connected to an indicating means which is arranged to emit a signal only when both sensing means are actuated. This avoids the possibility of more than one signal being emitted by a single poultry carcass during movement along the path.

Thus, there remains a need for systems and method having the capacity to integrate automated poultry unit counting with other systems and methods throughout the poultry processing facility.

### SUMMARY OF THE INVENTION

The present invention is directed to automated systems and methods for automatically controlling functions such as water, power, gas, and equipment usage in an animal processing facility, in particular at a poultry processing facility, wherein at least one sensor is provided for sensing the presence of each animal unit at the input of a predetermined process or system and for tracking each animal unit through the process or system using animal unit sensing outputs, while coordinating at least one function of the predetermined process or system in an automated, integrated manner based upon the animal unit sensing outputs.

Accordingly, one aspect of the present invention is to provide an automated system for controlling functions such as water, power, gas, and equipment usage at an animal processing facility, in particular at a poultry processing facility, the system including at least one sensor is provided for sensing the presence of each animal unit, wherein each of the at least one sensors is positioned at the input of a predetermined process or system and for counting and/or tracking each animal unit through the process or system, wherein each sensor provides a corresponding animal unit sensing output, and control system having inputs and outputs for coordinating at least one function of the predetermined process or system in an automated, integrated manner based upon the animal unit sensing outputs.

Another aspect of the present invention is to provide a method for controlling functions such as water, power, gas, and equipment usage in an animal or poultry processing facility wherein at least one sensor is provided for sensing the presence of each animal unit at the input of a predetermined process or system and for tracking each animal or bird unit through the process or system using animal or bird unit sensing outputs, while coordinating at least one function of the predetermined process or system in an automated, integrated manner based upon the animal unit sensing outputs.

These and other aspects of the present invention will become apparent to those skilled in the art after a reading of the following description of the preferred embodiment when considered with the drawings.

### BRIEF DESCRIPTION OF THE DRAWINGS

FIG. 1 is a schematic view of a poultry processing system constructed according to the present invention.

FIG. 2 is a flow chart diagram view of a method according to the present invention.

FIG. 3 shows a schematic diagram of a design example according to the present invention.

FIG. 4 shows a schematic representation of the control logic for the design example.

### DETAILED DESCRIPTION OF THE PREFERRED EMBODIMENTS

In the following description, like reference characters designate like or corresponding parts throughout the several views. Also in the following description, it is to be understood that such terms as “forward,” “rearward,” “front,” “back,” “right,” “left,” “upwardly,” “downwardly,” and the like are words of convenience and are not to be construed as limiting terms.

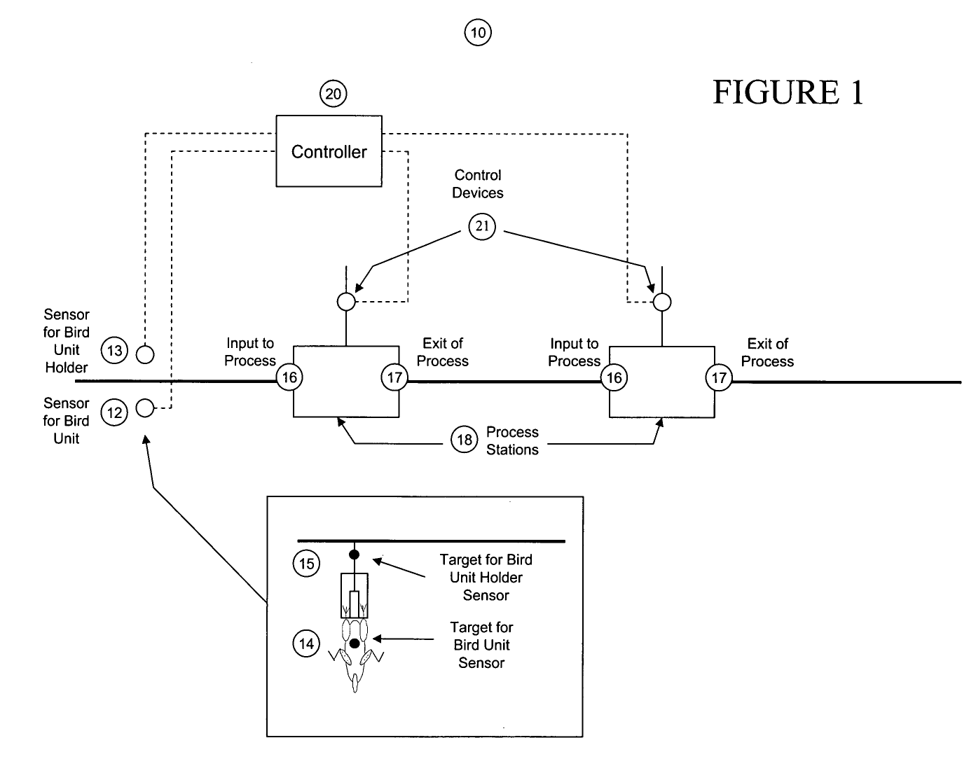

Referring now to the drawings in general, the illustrations are for the purpose of describing a preferred embodiment of the invention and are not intended to limit the invention thereto. As best seen in FIG. 1, a schematic view of an animal processing system, more particularly, a poultry processing system, constructed according to a preferred embodiment of the present invention, generally referenced 10, is shown.

A preferred embodiment of the system for controlling functions such as water, power, gas, and equipment usage in an animal processing system or facility, more particularly, a poultry processing system or facility, according to the present invention includes at least one sensor 12 for sensing the presence of each animal unit 14 and/or counting/tracking the number of each animal or bird unit holder 13, or in the case of a poultry processing system, each bird unit, wherein each of the at least one sensors is positioned at the input 16 of a predetermined process or station 18 and for counting and/or tracking each animal or bird unit through the process or station, wherein each sensor provides a corresponding animal or bird unit sensing output, and control system 20 having inputs and outputs for coordinating at least one function of the predetermined process or system in an automated, integrated manner by a control system having a controller 20 and control devices 21 based upon the animal or bird unit sensing outputs.

Preferably, the at least one sensor is capable of sensing the presence of an animal or bird unit and a corresponding animal or bird unit holder either individually and/or as a series of animal or bird unit holders, for counting and/or tracking the same. Also, preferably, the at least one sensor is capable of sensing a series of animal or bird unit holders and a corresponding animal or bird unit for each holder, the animal or bird units being removably held by the animal or bird unit holders. It is an important part of the present invention for the system to be capable of determining whether or not a corresponding animal or bird unit is held in each holder, so that the control system activates and/or deactivates the at least one function, which is preferably a water-, power-, or equipment-related function within a station or process, when the at least one sensor detects a predetermined number of animal or bird unit holders each of which having a corresponding animal or bird unit held thereby or a predetermined number of animal or bird unit holders not having any animals or birds therein.

Regarding the function, process, or station, the present invention provides a particular advantage for those applications that include water, power, gas, and equipment usage, since the system or method provides for coordinated action, such as starting or stopping water flow, power supply regulation, and/or equipment activation/deactivation, through a station based upon the presence of animal or bird units moving through that station, wherein the water can start automatically based on a signal from the control system when animal or bird units are passing through the system, the automated start time based upon animal or bird unit sensing outputs and a corresponding deactivation, speed, rate, or flow, based upon the total number of animals or birds in a given series and their location in the system. Significantly, the present invention system and methods provide for an integration of the sensors and control system so that bird units can be tracked through the overall animal or poultry processing processes or facility and activities using water, power, gas, and/or equipment throughout the facility may be coordinated based upon the number and location of the animal or bird units passing through the facility and processes.

The sensors may be selected from a variety of sensors appropriate for sensing the presence and/or absence of an item to be sensed. By way of example but not limitation, the sensors may be infrared (IR) sensors, proximity sensors, proximity switches, metal detection sensors, ultrasonic sensors, and the like, and combinations thereof. In any case, the sensors are preferably constructed, configured, and activated to sense a first animal or bird unit and/or animal or bird unit holder, or combination of both, entering a station, process or location within the animal or poultry processing facility. Preferably, the sensors are capable of sensing the number of animal or bird units and/or animal or bird unit holders, or combination of both passing by or through the input or entry to the station, process or location, and capable of tracking each animal or bird unit through the system. The control system is integrated with the sensor outputs relating to the animal or bird units and/or animal or bird unit holders, or combination of both, such that a function such as water flow can be activated or started just prior to the first animal or bird unit and/or animal or bird unit holder, or combination of both entering the station, process or location, and to deactivate the function after the last of the series of animal or bird unit(s), holder(s) and combination thereof exit that station, process or location. This optimizes the water, power and/or equipment usage at that station, process, or location automatically by integrating that information output from the sensors for at least one station, and also for a multiplicity of stations connected in series within the facility. When the line or series of animal or bird units and animal or bird unit holders stops, the control system detects and monitors where a given animal or bird unit and/or animal or bird unit holder is located within the facility, station, or process, noting that the combination of an animal or bird and corresponding holder does not exist together, i.e, a holder is present without an animal or bird held thereby. Thus, the sensor(s) may be strategically positioned at the beginning of a line or series that passes through a multiplicity of stations or processes, only requiring a sensing at that input and not having multiple sensors required at each station. The movement of the line and the distance traveled by the bird units/holders/combination is tracked by the control system so that the water, power, gas, and/or equipment usage throughout the entire facility may be controlled based upon those sensor outputs. When no animal or bird units are sensed within the corresponding animal or bird unit holders or clamps, then the control system tracks or counts a predetermined number of animal or bird unit holders before deactivating any processes. The distance between the first sensor and the series of stations corresponds to a number of animal or bird unit holders after which the station functions are activated and/or deactivated based upon the detection or sensing of animal or bird units in animal or bird unit holders or a predetermined number of bird unit holders without corresponding animal or bird units detected therein. Alternatively, each station, machine, piece of equipment, processes may have sensor(s) at their inputs for detecting the same and for activating/deactivating the functions provided thereby.

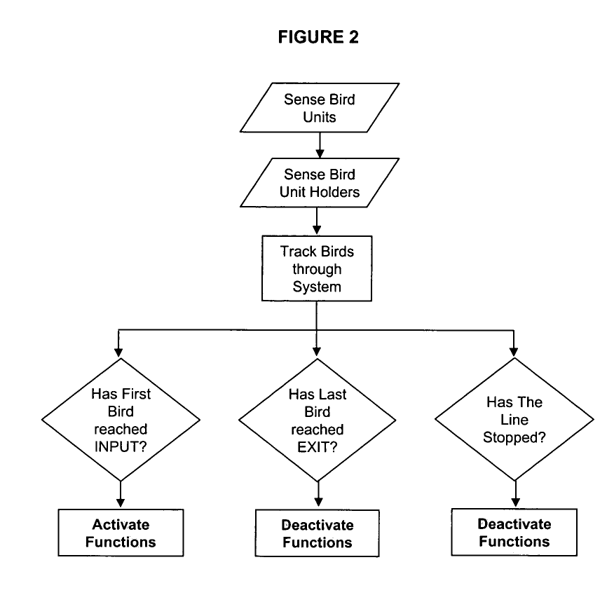

FIG. 2 is a flow chart diagram view of method steps according to a preferred embodiment of the present invention, the method generally referenced 30.

Such a method for controlling water, power, gas, and/or equipment usage in a poultry processing facility includes the steps of:
providing at least one sensor for sensing the presence of each animal or bird unit at the input of a predetermined process or system and for tracking each animal or bird unit through the process or system using animal or bird unit sensing outputs;
the at least one sensor sensing the presence of each animal or bird unit and/or animal or bird unit holder(s) at the input of a predetermined process or system, more preferably at least one sensor for sensing an animal or bird unit, and at least one sensor for sensing an animal or bird unit holder;
providing animal or bird unit outputs by each of the sensor(s);
providing a control system for receiving the animal or bird unit outputs;
the control system and sensor(s) coordinating at least one function of the predetermined process or system in an automated, integrated manner based upon the animal or bird unit sensing outputs.

Steps further included are:
the at least one sensor sensing the presence and/or absence of an animal or bird unit and a corresponding bird unit holder, either individually or in series, in particular in a predetermined quantity or number so that the control system may activate/deactivate a function, such as water, power, gas, and/or equipment usage, at stations or processes throughout the facility, based upon the number of animal or bird units inputting or entering a station or process and counting and/or tracking the total number of birds in a series in order to integrate automated systems and processes thereby.

Since the corresponding animal or bird units are removably held by the animal or bird unit holders, it may be that from time to time an animal or bird unit not placed in, accidentally releases from the holder and/or is removed from the process or station due to quality reasons. Advantageously, the present invention systems and methods permit continued functions, such as water, power, gas, and/or equipment usage without causing a false or erroneous cut-off or deactivation of the process if only one, two, or more bird units are not sensed along with a corresponding holder; rather, a predetermined number is provided such that false shut-offs do not occur, i.e., so that the sensors and control system can permit a longer passage of time or a greater number of empty holders to pass through the system before it is appropriate to deactivate the function due to an intended termination of animal or bird units passing through the process, station or facility on a given shift or day. Thus, the control system is preset or preprogrammed to deactivate the at least one function, such as water, power, gas, and/or equipment usage at a station, when the at least one sensor detects a predetermined number of animal or bird unit holders each of which not having a corresponding animal or bird unit held thereby.

Certain modifications and improvements will occur to those skilled in the art upon a reading of the foregoing description. By way of example, the present invention applies to any animal processing facility, station and/or process where animal units are processed, including but not limited to fish, hogs, cattle, and the like. All modifications and improvements have been deleted herein for the sake of conciseness and readability but are properly within the scope of the following claims.

Design Example(s)

This section outlines a few design examples, not necessarily optimized, but illustrative of what can be done for a poultry processing water usage control system and method, wherein the animal or bird unit count or sensed outputs are used by a control system to be integrated with control of water usage at various stations or processes within the facility. These design examples include the following to illustrate an application of the present invention.

Sensors

Infrared sensors ISC1 and ISD1 are used for sensing bird units and bird unit holders respectively. The sensors are positioned as shown in FIG. 1 to sense the presence of each bird unit and its corresponding bird unit holder. The transmitter for the bird unit sensor is positioned opposite its receiver and opposite the transmitter for the bird unit holder to prevent cross contamination of the infrared signals.

Controller

The system controller will track each bird unit through the system by counting its corresponding bird unit holders. Each piece of equipment or group of equipment that is to be controlled is a known and fixed distance of bird unit holders from the sensors. Accordingly, all distances along the processing line are measured by the number of bird unit holders between the bird unit holder sensors and the point to be identified.

Example Processing Station

The first processing station to be controlled consists of a Belt Spray and Oil Sack Cutter. The chlorinated water supply was re-piped so that a single valve, VE1, could control the station. In this case, the entrance to the Belt Spray is 27 bird unit holders from the sensors. In addition, the exit of the Oil Sack Cutter is located 56 bird unit holders from the sensors. The object of the system is to have valve VE1 open anytime there are bird units being processed in either the Belt Spray or Oil Sack Cutter and closed if there are no bird units within those two pieces of processing equipment. The system detects this condition by counting the appropriate number of bird unit holders from the time the first bird unit was sensed. In this case, when the first bird unit is sensed, the system will count bird unit holders and then open valve VE1. At any time during processing when the valve VE1 is open and the line stops, valve VE1 will close. When the line starts, the valve will reopen. When bird units are no longer being sensed, the system will count bird unit holders in order to deactivate the processing station and close valve VE1. In this case, the exit of the Oil Sack Cutter is located 56 bird unit holders from the sensors. When this number is reached in the bird unit holder count, and no other bird units have been sensed, VE1 will close.

Other Processing Stations

Similarly the Venter, Opener, and Eviscerator represent a processing station whose chlorinated water supply has been reconfigured to be controlled by valve VF1. The entrance to the Venter is 75 bird unit holders and the distance to the exit of the Eviscerator is 147 bird unit holders. The controller will open valve VF1 when bird units are detected between 75 and 147 bird unit holders and close the valve at any other time, and during line stops. The next chlorinated water supply system serves the Cropper, Neckbreaker, F.I.M., Bird Brush, and I/O Bird Washer and is controlled by valve VI1. This valve operates open when bird units are detected between 523 and 676 bird unit holders. In this case, potable water is supplied separately to the Bird Brush and the I/O Bird Washer. In addition, the I/O Bird Washer has a booster pump that must be controlled. Therefore, valve VG1 that serves potable water to the Bird Brush is opened when bird units are detected between 602 and 621 bird unit holders. Similarly, valve VH1 and pump PE1 are controlled open and on, respectively, when bird units are detected between 647 and 676 bird unit holders.

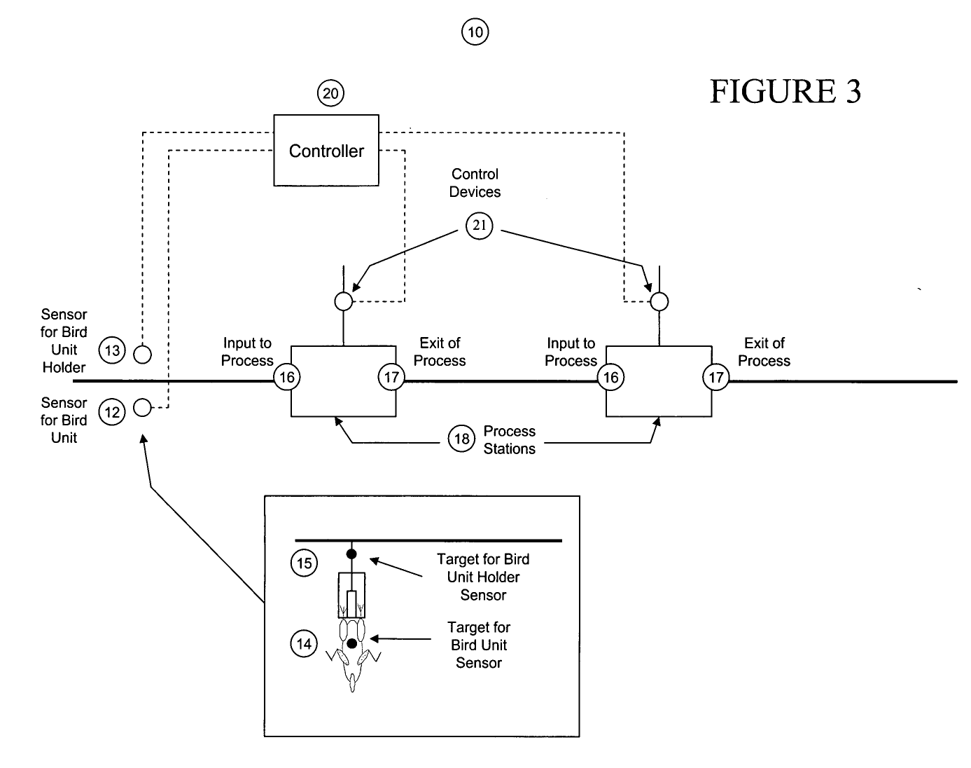

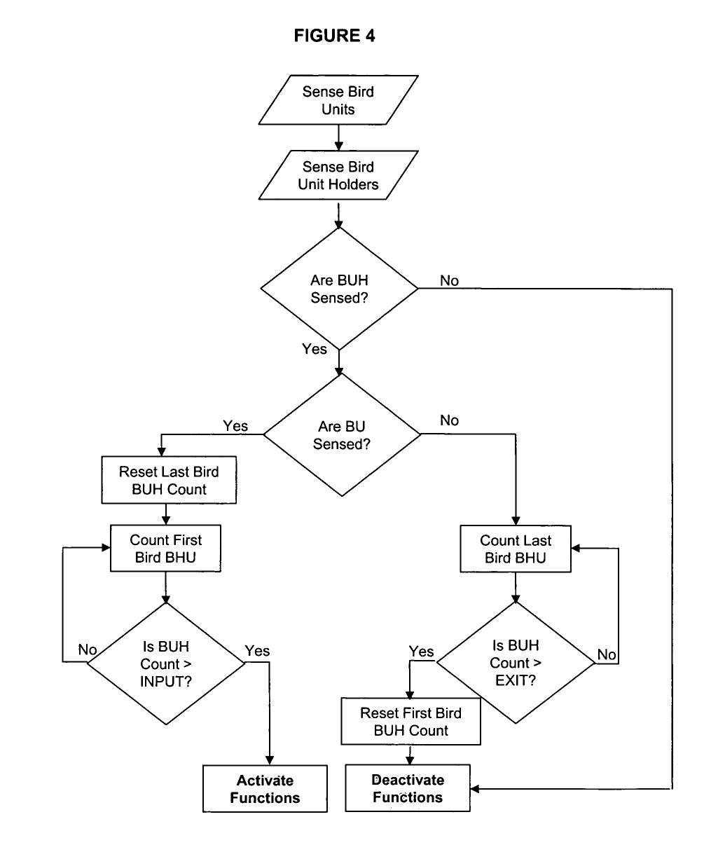

FIG. 4 shows a schematic representation of the control logic used for controlling systems and methods of embodiments of the present invention, in particular for the design example shown in FIG. 3 and described in the foregoing.

1. A system for controlling functions in an animal processing facility, the system including at least one sensor is provided for sensing the presence of each animal unit, wherein each of the at least one sensors is positioned at the input of a predetermined process or station and for tracking each animal unit through the process or station, wherein each sensor provides a corresponding animal unit sensing output, and control system having inputs and outputs for coordinating at least one function of the predetermined process or system in an automated, integrated manner based upon the animal unit sensing outputs.

2. The system of claim 1, wherein the at least one sensor is capable of sensing the presence of a animal unit and a corresponding animal unit holder.

3. The system of claim 1, wherein the at least one sensor is capable of sensing each of a series of animal unit holders.

4. The system of claim 1, wherein the at least one sensor is capable of sensing each of a series of animal unit holders and a corresponding animal unit removably held by the animal unit holders.

5. The system of claim 1, wherein the at least one sensor is capable of sensing each of a series of animal unit holders and wherein the system is capable of determining whether a corresponding animal unit is held thereby.

6. The system of claim 1, wherein the control system activates the at least one function when the at least one sensor detects a predetermined number of animal unit holders each of which having a corresponding animal unit held thereby.

7. The system of claim 1, wherein the control system deactivates the at least one function when the at least one sensor detects and counts a predetermined number of animal unit holders each of which not having a corresponding animal unit held thereby.

8. The system of claim 1, wherein the at least one function is water-, gas-, power, and/or equipment-related.

9. The system of claim 1, wherein the predetermined process includes water, power, gas, and/or equipment usage.

10. The system of claim 1, wherein the control system controls water usage at each of the predetermined processes or station based upon the animal unit outputs provided by the sensors.

11. A method for automatically controlling at least one function in an animal processing facility wherein at least one sensor is provided for sensing the presence of each animal unit at the input of a predetermined process or system and for tracking each animal unit through the process or system using animal unit sensing outputs, while coordinating at least one function of the predetermined process or system in an automated, integrated manner based upon the animal unit sensing outputs.

12. The method of claim 11, further including the step of the at least one sensor sensing the presence of an animal unit and a corresponding animal unit holder.

13. The method of claim 11, further including the step of the at least one sensor sensing each of a series of animal unit holders.

14. The method of claim 11, further including the step of the at least one sensor sensing each of a series of animal unit holders and a corresponding animal unit removably held by the animal unit holders.

15. The method of claim 11, further including the steps of the at least one sensor sensing each of a series of animal unit holders and the system determining whether a corresponding animal unit is held thereby.

16. The method of claim 11, further including the step of the control system activating the at least one function when the at least one sensor detects a predetermined number of animal unit holders each of which having a corresponding animal unit held thereby.

17. The method of claim 11, further including the step of the control system deactivating the at least one function when the at least one sensor detects a predetermined number of animal unit holders each of which not having a corresponding animal unit held thereby.

18. The method of claim 11, wherein the at least one function is water-, gas-, power, and/or equipment-related.

19. The method of claim 11, wherein the predetermined process includes water, gas, power, and/or equipment usage.

20. The method of claim 11, further including the step of the control system controlling water usage at each of the predetermined processes or station based upon the animal unit outputs provided by the sensors.

21. A system for controlling functions in an animal processing facility, the system including at least one sensor is provided for sensing the presence of each animal unit and a corresponding animal unit holder and for counting the same combination, wherein each of the at least one sensors is positioned at the input of a predetermined process or station and for counting each animal unit through the process or station, wherein each sensor provides a corresponding animal unit sensing output, and control system having inputs and outputs for coordinating at least one function of the predetermined process or system in an automated, integrated manner based upon the animal unit sensing outputs.

22. The system of claim 21, wherein the at least one sensor is capable of tracking each animal unit and corresponding animal unit holder throughout the process.
